(19) United States
(12) Patent Application Publication
(10) Pub. No.: US 2025/0320428 A1
(43) Pub. Date: Oct. 16, 2025

(54) HYDROTHERMAL FEEDSTOCK TREATMENT

(71) Applicant: Crown Iron Works Company, Blaine, MN (US)

(72) Inventors: Benjamin Floan, Andover, MN (US); Wade S. Martinson, Minneapolis, MN (US); Aaron M. Iwen, Minneapolis, MN (US); Ryan Popinga, Lexington, NC (US); Patrick Harrington, Blaine, MN (US); William Michael McDonald, Maplewood, MN (US)

(73) Assignee: Crown Iron Works Company, Blaine, MN (US)

(21) Appl. No.: 19/245,529

(22) Filed: Jun. 23, 2025

Related U.S. Application Data
(63) Continuation-in-part of application No. 18/929,695, filed on Oct. 29, 2024.
Application No. 18/929,695 is a continuation-in-part of application No. 18/680,266, filed on May 31, 2024.
(60) Provisional application No. 63/470,602, filed on Jun. 2, 2023.

(51) Int. Cl. C11B 13/02

(52) U.S. Cl. CPC C11B 13/02

(57) ABSTRACT

The disclosure provides a process for a hydrothermal feedstock treatment including direct steam injection and cooling, which may be performed in the absence of a reactor. The process can be used to reduce inorganic and organic contaminants, such as salts, minerals, metals, asphaltenes, polymers, and coke precursors in both renewable and non-renewable feedstocks. The hydrothermal feedstock treatment may also be used in soap acidulation processes.

### CROSS-REFERENCE TO RELATED APPLICATION

The present application claims priority to U.S. patent application Ser. No. 18/929,695, filed on Oct. 29, 2024, and entitled HYDROTHERMAL FEEDSTOCK TREATMENT,” which claims priority to U.S. patent application Ser. No. 18/680,266, filed on May 31, 2024, and entitled “HYDROTHERMAL FEEDSTOCK TREATMENT,” which claims priority to U.S. Provisional Application No. 63/470,602, filed on Jun. 2, 2023, and entitled “HYDROTHERMAL FEEDSTOCK TREATMENT,” the entire disclosure of which is expressly incorporated by reference herein.

### FIELD

The present disclosure relates generally to a hydrothermal feedstock treatment process. More particularly, the present disclosure relates to hydrothermal feedstock treatment processes by treatment with direct steam injection.

### BACKGROUND

The ever-increasing demand for renewable fuels and chemicals has forced refineries to look to alternative hydrocarbon sources and ways to upgrade and convert these sources or feedstocks into viable products.

### SUMMARY

The disclosure provides a process for a hydrothermal feedstock treatment including direct steam injection.

According to one example (“Example 1”), the process includes the step of providing a water feed and a feedstock feed. The feedstock is provided at a temperature of between about 20° C. and 50° C. and a pressure of at least about 0.05 MPa. The water is provided at a temperature of between about 20° C. and 40° C. and a pressure of at least about 0.05 MPa. The feedstock and the water feed are combined at a mix ratio of from 0.1:1 to 1:1 to form a combined feedstock and water feed stream. The combined feedstock and water feed stream may be pressurized to 2 MPa to 8 MPa. The process further includes directly injecting (and condensing) steam at a pressure from 5 MPa to 8 MPa, or about 6 MPa into the combined feedstock and water feed stream. The steam may be injected at a ratio of 0.1:1 to 0.4:1 to form a heated combined feedstock and water feed stream. The temperature of the heated and pressurized combined feedstock and water stream may be from 150° C. to 280° C. Alternatively, the temperature of the heated and pressurized combined feedstock and water stream may be greater than or equal to 200° C. but less than or equal to 260° C., such as 200-260° C., 220-260° C., 230-260° C., 240-260° C., 210-250° C., or 220-250° C., inclusive.

The heated combined feedstock and water stream may be supplied to a hydrothermal reactor, such as a tank, or a pipe, tube, or high-pressure shell and tube exchanger, optionally heating the stream further to a temperature of from 200° C. and 370° C. The residence time in the reactor is sufficient such that some contaminants are liberated from the feedstock.

The reactor is at a temperature of between about 200° C. and 370° C. and the residence time of the heated combined feedstock and water feed stream in the reactor is between about 1 second and 120 minutes, and a product stream formed.

After treatment in the reactor, the product stream is transferred to a post-treatment process. The post-treatment process may include cooling and/or depressurizing the product stream, prior to feeding the product stream into a separator, optionally adding process chemicals, such that phase separation is initiated. The post-treatment process is maintained at a temperature of between about 50° C. and 100° C.

The depressurizing step may involve flashing a portion of a water stream in the cooled product stream to generate steam. The separated water stream may be reheated. An economizer or a plurality thereof may be used to reheat the separated water stream. Economizers are primarily heat transfer surfaces used to preheat boiler feedwater before it enters, for example, a drum or a furnace surface, depending on the boiler design. Economizers typically include a number of tubes. The tubes may have fins or other structures to increase their heat absorption from gas passing over the tubes. The term “economizer” comes from early use of such heat exchangers to reduce operating costs or economize fuel usage by recovering extra energy from flue gas.

The separated water stream can be chemically treated or recycled. The separated water stream may be treated by anaerobic digestion. Anaerobic digestion can be performed in an anaerobic digester, where the environment is an inert atmosphere where oxygen is absent. Anaerobic digestion can be performed in the range 45° C. to 70° C., 48° C. to 60° C., 45° C. to 70° C., 49° C. to 59° C., or 50° C. to 55° C., inclusive. The anaerobic digestion process can be performed for a duration of 6 hours to 100 days, 12 hours to 80 days, 1 day to 60 days, 5 days to 40 days, or 10 days to 30 days, inclusive.

According to a second example (“Example 2”), the process includes providing a feedstock feed. The feedstock is provided at a temperature of between about 20° C. and 50° C. and a pressure of at least about 0.05 MPa. Optionally, the feedstock stream may be pressurized to 2 to 8 MPa. The process further includes directly injecting (and condensing) steam at a pressure from 5 to 8 MPa, or about 6 MPa into the feedstock stream. The steam may be injected at a ratio of 0.1:1 to 0.4:1 to form a heated combined feedstock and water feed stream. The temperature of the heated and pressurized combined feedstock and water stream may be from 150 to 280° C. Alternatively, the temperature of the heated feedstock may be greater than or equal to 200° C. but less than or equal to 260° C., such as 200-260° C., 220-260° C., 230-260° C., 240-260° C., 210-250° C., or 220-250° C., inclusive. The heated and pressurized combined feedstock and water stream is supplied to a hydrothermal reactor or high-pressure shell and tube exchanger, and further processed as is described in Example 1.

According to a third example (“Example 3”), a process involving degummed feedstock can substantially reduce the amount of various inorganic compounds, such as metals, in a reactor feedstock, reactor product oil, and centrifuged reactor product oil.

According to another example (“Example 4”), the process can be performed in the absence of a reactor and instead involve providing a water feed and a feedstock feed to a pipe. The feedstock is provided at a temperature of between about 20° C. and 50° C. and a pressure of at least about 0.05 MPa. The water is provided at a temperature of between about 20° C. and 40° C. and a pressure of at least about 0.05 MPa. The feedstock and the water feed are combined at a mix ratio of from 0:1 to 1:1 to form a combined feedstock and water feed stream. The combined feedstock and water feed stream may be pressurized to 2 MPa to 8 MPa. The process further includes directly injecting (and condensing) steam at a pressure from 5 MPa to 8 MPa, or about 6 MPa into the combined feedstock and water feed stream. The steam may be injected at a ratio of 0.1:1 to 0.4:1 to form a heated combined feedstock and water feed stream. The temperature of the heated and pressurized combined feedstock and water stream may be from 150° C. to 280° C. Alternatively, the temperature of the heated and pressurized combined feedstock and water stream may be greater than or equal to 200° C. but less than or equal to 260° C., such as 200-260° C., 220-260° C., 230-260° C., 240-260° C., 210-250° C., or 220-250° C., inclusive.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is diagram of one embodiment of a process for hydrothermal feedstock treatment according to the present invention;

FIG. 2 is diagram of an alternative embodiment of a process for hydrothermal feedstock treatment according to the present invention;

FIG. 3 is diagram of an alternative embodiment of a process for hydrothermal feedstock treatment according to the present invention;

FIG. 4 is diagram of an alternative embodiment of a process for hydrothermal feedstock treatment according to the present invention;

FIG. 5 is a diagram of an alternative embodiment of a process for hydrothermal feedstock treatment including water recycling according to the present invention;

FIG. 6 is a diagram of a pretreatment degumming process according to the present invention;

FIG. 7 is a water clean-up process for wastewater expelled from the processes in FIGS. 1, 2, 3, 4, 5, 9, and 10;

FIG. 8 is a flow chart of the synergy between the processes of the present disclosure;

FIG. 9 is a diagram of a product stream multi-separation process that may use the product stream of any of the processes described in FIGS. 1-5; and

FIG. 10 is a diagram of a soap acidulation process that may use any of the hydrothermal feedstock treatment processes described in FIGS. 1-5.

### DETAILED DESCRIPTION

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

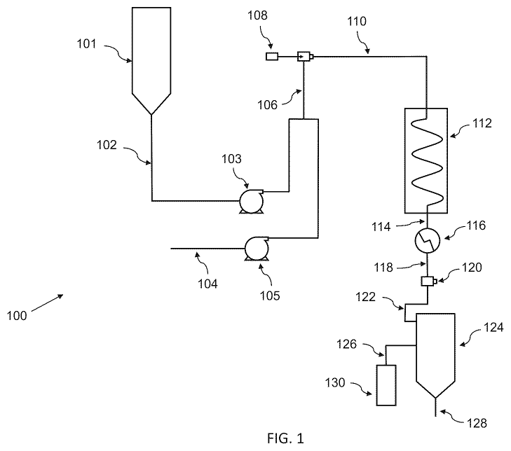

The processes shown in FIGS. 1, 2, 3, 4, 5, 6, 7, 8, 9, and 10 are provided as an example of the various features of the method and, although the combination of those illustrated features is clearly within the scope of invention, that example and its illustration is not meant to suggest the inventive concepts provided herein are limited from fewer features, additional features, or alternative features to one or more of those features shown in the figures.

The feedstock may include renewable or non-renewable organic feedstock. The feedstock can include glyceride-based lipids, such as triglycerides derived from plant and animal sources, renewable plant oil, algal and microbial oils, waste vegetable oils, brown grease, animal fats, and soapstock; oils from recycled petroleum products, plastics, and elastomers; and petroleum crude oil or crude oil fractions. Animal fats can include lard, tallow, poultry, among others.

The instant process has numerous advantages over other cleanup processes such as chemical degumming, desalting processes, or other chemical, extraction, or thermal processes. Advantages may include a small equipment footprint that can be co-located with a conventional refinery or implemented in the field; the ability to recover valuable aqueous or organic products or byproducts; and incorporation of integral high-energy atmospheric vapor-liquid separation or rectification of the product stream that eliminates the need for vacuum distillation to separate or concentrate products. Additionally, eliminating the need for heat transfer surfaces can significantly reduce energy losses and fouling potential, leading to increased yield and utilization. The process results in a high product yield with significantly reduced concentrations of salts, metals, and minerals, such as silicas, oxides, carbonates, sulfates, and phosphates. The system is desirable for processing renewable feedstocks which are subject to transesterification, esterification, hydrolysis, saponification, and hydrogenation. The system is specifically desirable for use in processing renewable feedstocks which results in renewable diesel.

The feedstock may be pretreated before the process. Pretreatment may include degumming, such as water degumming. Degumming may be used to remove phospholipids (gums) from the feedstock before it is further processed as described below. For example, steam may be directly or indirectly injected into the feedstock, causing any phospholipids in the feedstock to hydrate and swell. The hydrated phospholipids may be separated from the feedstock using a separator, such as a gravity separator, centrifuge, or other separating means. The pretreated feedstock may then be supplied to further cleaning processes.

Feedstock and/or water stream may be treated with additives,, at any point prior to steam injection such as during pretreatment, prior to the combination of the feedstock stream with a water stream, or after the combination of the feedstock stream with a water stream. The additives may be added into the feedstock stream by a pump or other suitable device. The amount of additives may vary by process and purpose of the additive.

For example, additives may be added into the feedstock, water, or feedstock and water stream in an amount greater than 1 mL, greater than 10 mL, greater than 100 mL, greater than 1000 mL, greater than 10,000 mL, greater than 100,000 mL, or greater than 1,000,000 mL, or any range using any two of the foregoing values as endpoints, such as 1 mL to 1,000,000 mL, 10 mL to 100,000 mL, 100 mL to 10,000 mL, or 1000 mL to 10,000 mL

Suitable additives for addition to the hydrothermal feedstock treatment process may include acids such as sulfuric acid, hydrochloric acids, and phosphoric acid; bases such as sodium hydroxide, potassium hydroxide, and calcium hydroxide; salts such as sodium chloride, zinc chloride, and magnesium chloride; ionic liquids configured to dissolve cellulose and lignin to improve biomass fractionation; organic solvents; inorganic solvents; reducing agents such as formic acid and sodium borohydride; reducing and/or oxidizing agents such as hydrogen gas, oxygen gas, air, H₂O₂, and formic acid; catalysts such as alkaline catalysts, acidic catalysts, transition metal catalysts, and zeolites, such as NaOH, KH, HCl, H₂SO₄, Ru, Ni, C, Mo, and Pt; salts and ionic liquids, such as ZnCl₂, FeCl₃, and MgCl₂; nutrient additives such as nitrogen, phosphorous, or trace minerals; sugars; flavoring agents; surfactants; emulsifiers; inhibitors; scavengers; and combinations thereof.

The process may be a continuous-flow or batch process. The process can involve a reactor, such as a hydrothermal reactor. The reactor can have an outer stainless steel shell and a corrosion-resistant inner liner, such as a liner including PTFE or polypropylene (PPL). The reactor may be a tubular or pipe reactor. In some examples, the reactor conditions may be transient, or not held at a constant temperature or pressure, such that the heated feedstock is immediately cooled. In other examples, the reactor may facilitate laminar flow conditions and have a continuous flow design.

Alternatively, the process may not involve a reactor and instead include a tank, pipe, tube, or shell and tube heat exchanger. Whereas a hydrothermal reactor is not typically replaceable by a tank, pipe, tube, or shell and tube heat exchanger, the conditions of the instant feedstock purification process, for example, the laminar flow conditions, allow for such an embodiment.

The feedstock may be renewable or non-renewable organic feedstocks, such as renewable plant oil, algal and microbial oils, waste vegetable oils, brown grease, tallow; oils from recycled petroleum products, plastic, and elastomers; and petroleum crude oil or crude oil fractions. The feedstock may further contain contaminants. The process disclosed herein separates undesirable contaminants such as minerals, metals, salts, and asphaltenes, from the feedstock to produce clean oil. Other contaminants may include mycotoxins, pesticide residues, e.g., organochlorines, organophosphates, or carbamates, polycyclic aromatic hydrocarbons (PAHs), phthalates, solvent residue, antioxidants, or polychlorinated biphenyls (PCBs), among others.

By “clean” it is meant that contaminants in the product have been reduced by greater than 90%, such as by more than 95%, often resulting in trace amounts (near or below typical analytical method detection limits) of contaminants compared to the feedstock. The level of contaminants in the clean oil is minimized to greatly reduce deposition, polymerization, and coking in downstream conversion equipment and deactivation or fouling of downstream conversion catalysts.

The process can involve controlled dissociation of contaminants from feedstock molecules, resulting in the selective release of contaminants while preserving the desired product species. Feedstock contaminants may dissociate from the original molecular structure of the feedstock. Dissociation of contaminants leads to separation and liberation of impurities or undesired species that were previously incorporated into the molecular frameworks of the feedstock. Accordingly, the process may involve collection of contaminants liberated from the molecular structure of a feedstock.

Feedstock may be combined with water, such as water supplied by a water feed, a steam injector, or from each source, prior to entering a reactor, such as a hydrothermal reactor. Prior to steam injection, feedstock can be heated, such as preheated, to a temperature of from 100° C. to 450° C., 100° C. to 400° C., 100° C. to 200° C., 150° C. to 250° C., 150° C. to 350° C., 150° C. to 300° C., 200° C. to 300° C., or 250° C. to 300° C., inclusive.

Steam injection can heat feedstock to a temperature of greater than or equal to 200° C. but less than or equal to 260° C., such as 200-260° C., 220-260° C., 230-260° C., 240-260° C., 210-250° C., or 220-250° C., inclusive. In some examples, feedstock is mixed with water prior to steam injection. Water can be provided by a water feed that is separate from the steam injector. In such case, steam injection can heat a combined feedstock and water stream to a temperature of greater than or equal to 200° C. but less than or equal to 260° C., such as 200-260° C., 220-260° C., 230-260° C., 240-260° C., 210-250° C., or 220-250° C., inclusive.

Steam injection can involve a steam supply pressure of 500 psig to 1000 psig, 500 psig to 800 psig, 650 psig to 900 psig, 750 psig to 1000 psig, 800 psig to 900 psig, or 700 psig to 900 psig, inclusive. The water feed may or may not be heated and/or pressurized.

In fluid dynamics, laminar flow is the property of fluid particles to follow layered paths, where each layer moves smoothly past the adjacent layers with little to no mixing. The Reynolds number (Re) is a dimensionless parameter that aids in describing whether a fluid flow is laminar or turbulent by representing the ratio between the inertial forces and the viscous forces acting on the fluid. Laminar flow generally occurs when the fluid is moving slowly or the fluid is highly viscous. In this case, the viscous forces dominate, and the flow is smooth and predictable. As the Reynolds number increases, e.g., by increasing the flow rate of the fluid, the flow will transition from laminar to turbulent flow.

In some examples, disclosed processes may not involve turbulent flow or a fluid flow characterized by a Reynolds number of greater than 2000. Contents of a hydrothermal reactor, such as a heated and pressurized mixture of feedstock and water stream, can have a laminar flow within the hydrothermal reactor, e.g., characterized by a Reynolds number of less than about 2300, 2000, 1750, or 1500. In other examples, a mixture containing feedstock and water stream in the reactor may have a Reynolds number of from 50 to 750, 75 to 1750, 100 to 1650, 250 to 1500, 500 to 2000, 750 to 2000, 1000 to 2000, 500 to 1000, 750 to 1250, 1250 to 1800, or 1500 to 2000, wherein each range is inclusive.

Re may defined as Re=ND²/v, where N is blade rotations per second, D is the impeller diameter and v is the kinematic viscosity of the fluid. Alternatively, Re can be Re=ρVD/μ, where V represents free-stream fluid velocity, D is characteristic distance or pipe diameter, ρ is fluid density, and μ is fluid viscosity (dynamic).

Residence time of reactor contents including feedstock and water can range from 1 second to 120 minutes, optionally between about 5 seconds to 5 minutes, optionally between about 30 seconds to 5 minutes, optionally between about 1 to 3 minutes, optionally between about 1 to 6 minutes, optionally between about 2 to 4 minutes, optionally between about 30 to 60 seconds, optionally between about 1 minutes to 60 minutes, optionally between about 2 minutes to 30 minutes, optionally between about 5 minutes to 15 minutes, or optionally between about 10 seconds to 10 minutes, where each range is inclusive.

Following steam and injection, the heated feedstock, optionally combined with a heated water stream, may be immediately cooled, such that cooling occurs immediately after heating without any intervening steps. For example, the heated feedstock and water stream can be cooled less than 180 seconds, 120 seconds, 60 seconds, 30 seconds, or 15 seconds after exiting a reactor, pipe, tube, or other vessel. In other embodiments, such as those that do not involve a reactor, the heated feedstock and water stream can be cooled less than 180 seconds, 120 seconds, 60 seconds, 30 seconds, or 15 seconds after reaching a temperature of 265° C., 260° C., 255° C., 250° C., 245° C., 240° C., 230° C., 225° C., or 220° C.

The cooling process can reduce the feedstock temperature from 200-260° C., 220-260° C., 230-260° C., 240-260° C., 210-250° C., or 220-250° C. 230° C.-260° C. to 90° C. or less, 70° C. or less, 50° C. or less, or 30° C. or less over a period of 30 seconds to 15 minutes, 30 seconds to 10 minutes, 30 seconds to 5 minutes, or 30 seconds to 1 minute, where each range is inclusive.

The contaminated feedstocks may be petroleum-based feedstocks, such as petroleum crude oil, shale oil, petroleum refinery intermediate streams (such as ATBs or vacuum tower bottoms (VTB)), pyrolysis oils, recycled plastics, coal liquids, used motor oil, and mixtures thereof. Alternatively, the contaminated feedstock may be renewable feedstock, such as a plant oil. Suitable plant oils for treating according to the present invention include oils of canola, Carinata, castor, Jatropha, palm, Pongamia, soy bean, tung, and/or corn (such as derived from distiller grains), soapstock, waste vegetable oil, yellow grease (from cooking oil), brown grease (from grease traps and wastewater treatment), highly acidic oils (also referred to as acidic oils), animal tallow, algal oil, microbial oil, terpenes and other pine-related byproducts from tall oils, or other biosynthetic oils (such as derived from pyrolysis, esterification, oligomerization, or polymerization) and mixtures thereof.

The feedstock can include an acidic oil. The acidic oil can be alternatively referred to as an acid oil or an acidulated soapstock. Alkali refining of a crude oil results in a soapstock, which then undergoes an acidulation step, for example, with sulfuric acid, to convert the soap into free fatty acids, thereby forming the acidulated soapstock or acid oil product. Acidulated soapstock is typically rich in free fatty acids relative to crude oil. In one illustrative example of differentiating a plant acid oil from a plant oil feedstock, soybean acid oil is derived from the soapstock byproduct generated during the alkali refining process of crude soybean oil, while soybean oil itself is the main product extracted from soybeans.

The feedstock may contain less than 5%, less than 10%, less than 15%, or less than 20% of an acid oil. For example, the feedstock can contain an acid oil in a total amount of about 1-5%, 1-10%, 1-15%, 10-19%, or 15-19%. Alternatively, the feedstock may contain an acid oil in an amount of greater than 80%, greater than 85%, greater than 90%, or greater than 95%. For example, the feedstock can contain an acid oil in a total amount of 80-100%, 80-90%, 85-95%, 90-100%, or 96-100%.

Contaminants that may be removed include inorganic materials, such as halides (e.g., Cl, Br, I) phosphorus and phosphorus-containing species, alkali metals and metalloids (e.g., B, Na, K, Si), and other metals (e.g., Ca, Fe, Mg, Ni, V, Zn). Organic contaminants for removal may include asphaltenes, polymers (such as polyesters and/or polypropylenes), high molecular weight organic compounds or waxes (such as containing more than 50-60 carbon atoms and/or having a boiling point greater than 600° C.), petroleum coke (petcoke), and/or coke precursors. The process may result in clean oil by achieving more than 90% (such as more than 95%) reduction in phosphorus, salt, mineral, and metal content relative to the starting material. In phospholipid feedstocks, phosphorus content is reduced from thousands of parts per million (ppm) to less than 100 ppm at a fraction of the yield loss associated with conventional refining.

The process can result in a treated oil that has less than about 10 ppm, 5 ppm, 1 ppm, 0.5 ppm, or 0.1 ppm of a contaminant. The process may result in a treated oil that has at least 50%, 100%, 250%, 500%, 750%, or 1000% less of a contaminant relative to the original feedstock oil. The process may result in a treated oil that has from about 1 to 50%, 50 to 100%, 80 to 125%, 90 to 100%, 75 to 150%, or 100 to 200%, less of a contaminant relative to the original feedstock oil.

The process may involve use of feedstocks that have undergone phospholipid removal, such as by degumming or another treatment method. Exemplary degumming methods include water degumming, enzyme assisted water degumming, acid degumming, and combinations thereof.

In the water degumming process, water is added to a feedstock, such as a crude oil, and the feedstock and water are mixed together to aid the hydration of the phospholipids present in the feedstock. The hydration of the phospholipids or “gums” causes the gums to swell and agglomerate as a flocculent, which is subsequently separated from the remainder of the feedstock. The feedstock obtained from this technique is generally referred to as “degummed,” despite being only partially degummed. For example, water degummed oil may still contain a high amounts of phospholipids, especially non-hydratable phospholipids. In such cases, water degumming can be combined with other degumming or processing techniques, such as caustic refining or phospholipase A (PLA) enzyme degumming, to produce a feedstock of improved stability and color.

Enzymatic degumming, also referred to as enzymatic refining may be employed for total removal of phospholipids, e.g., alone or in combination with other degumming treatments. Enzymatic degumming involves an enzymatic dismemberment of phospholipid constituents, such as fatty acids or phosphate derivatives. This transformation of phospholipids in a feedstock alters its emulsification properties such that less oil is lost when the gums are separated from the oil, e.g., relative to water degumming. Phospholipase enzymes are primarily involved in enzymatic degumming. Exemplary phospholipases include phospholipase A1 (PLA1), phospholipase A2 (PLA2), phospholipase C (PLC), phospholipase D (PLD), and combinations thereof. PLC is capable of cleaving phosphate groups, and PLA cleaves fatty acid groups. Selection of an enzyme for enzymatic degumming of a feedstock can be guided by the content of the feedstock, such as the phospholipid composition, the desired level of degumming, and processing conditions, such as temperature and pH, which can affect enzyme activity.

Water and enzyme degumming strategies can be combined for enzyme-assisted water degumming or enzymatic water degumming, which can be used to degum feedstocks containing a high amount of hydratable phospholipids. This approach can be used to react the hydratable phospholipids, converting them into diacylglycerols, while maintaining the non-hydratable phospholipids in the feedstock, such as crude oil. Enzymes utilized for this process include PLC and phosphatidyl inositol phospholipase (PI-PLC). In an illustrative example of the enzyme-assisted water degumming process, water and PLCs are added to crude oil with mixing. The enzymes react with the phospholipids in the oil with shear mixing to aid in the conversion of phosphatidyl choline (PC), phosphatidyl ethanolamine (PE), to diacylglycerols in the oil. The heavy phase (water, denatured protein, and phosphor-compounds) has a specific gravity higher than that of the oil and may be separated by settling, filtration, or the industrial practice of centrifugation. The enzyme-assisted water degumming process predominately removes the hydratable phospholipids. The remaining phospholipids, e.g., measured as the salts of phosphatidic acid can be removed in subsequent processing operations.

In a further example, acid degumming can be applied to a feedstock, such as a crude oil, for substantial removal of phospholipids. For example, crude oil may be treated with phosphoric acid, citric acid, malic acid, formic acid, acetic acid, or a combination thereof. The acid improves the hydrophilic nature of the non-hydratable phospholipids, thus aiding in their removal. Water is then added to the acid-treated crude oil, and the oil is mixed to aid the hydration of the phospholipids. The hydration of the phospholipids or “gums” causes the gums to swell and agglomerate as a flocculent, which is subsequently removed. The acid degumming process removes most of the phospholipids but may require additional processing. As in the water degumming process, some oil is entrained and considered a process loss.

Feedstock may contain chlorophyll. For example, triacylglycerol oils from oilseeds such as soybean and canola, and oil fruits, such as palm and algal source oils, contain chlorophyll. Even though several steps in a typical oil production process can result in the removal of chlorophyll, including seed crushing, oil extraction, degumming, caustic treatment, and bleaching, chlorophyll can persist in a feedstock.

Low levels of chlorophyll are advantageous because chlorophyll pigments can impart an undesirable color and induce oxidation of oil during storage, thereby undermining storage stability and promoting deterioration. In the edible oil processing industry, a bleaching step is employed to lower chlorophyll levels to as low as 0.02 ppm to guarantee oil quality in terms of color and organolepticity. This bleaching step increases processing cost and reduces oil yield due to entrainment in the bleaching clay. The “spent” clay then must be disposed of in an environmentally conscious manner and precaution must be taken during transport, as spontaneous combustion is a risk of acid-treated material and adsorbed oil.

Treatment of a feedstock containing chlorophyll in accordance with disclosed processes can reduce the amount of chlorophyll in the treated feedstock to levels of less than about 200 ppb, 150 ppb, 100 ppb, 50 ppb, or 25 ppb. For example, treated feedstock may contain chlorophyll in an amount of 1 to 150 ppb, 10 to 100 ppb, 25 to 75 ppb, 30 to 50 ppb, 15 to 30 ppb, 1 to 25 ppb, or 5 to 15 ppb, wherein each range is inclusive. In some embodiments, disclosed processes do not involve bleaching of either a feedstock or a treated feedstock.

The system disclosed herein may include a high-temperature, high-pressure, hydrothermal reactor system coupled with components for separation and/or recovery of a clean oil product. The process may be operated in a manner that produces a clean petroleum crude oil fraction, clean glycerides from renewable feedstocks, and/or clean distillate fractions from petroleum or renewable oils. For example, the concentration of inorganic contaminants is reduced to the degree that the resultant clean oils may be effectively upgraded using conventional refinery hydroprocessing operations (hydrotreating, hydrocracking, and/or hydroisomerization) with reduced coke formation, reduced catalyst fouling, and reduced catalyst deactivation. Effluent streams may be recovered, recycled, or refined to recover valuable byproducts.

In addition to degumming crude feedstock, additional refining or purification processes may also be performed on crude feedstock or feedstock treated in accordance with the processes described herein.

Additional refining or purification processes may include any of neutralization, such as to remove free fatty acids, bleaching, e.g., to remove color and other contaminants, deodorization, such as to remove undesirable odors and flavors, and winterization or dewaxing to remove waxes or improve cold stability. Selective removal of certain compounds may also be performed, such as the selective hydrolysis of triglycerides.

Gums can contribute to refining losses and darken feedstock as they decompose due to their thermal instability. Whereas degumming can remove hydratable and non-hydratable gums from a feedstock, such as a plant oil, neutralization is a separate step that occurs after degumming to neutralize free fatty acids (FFA) present in the oil. Neutralization can involve adding an alkalizing agent, such as caustic lye, to neutralize a contaminant. In one example, neutralization of FFAs transforms them into soap that can be separated from oil. Such processes can also contribute to the elimination of non-hydratable gums and metals.

Deodorization can involve steam deodorization, which transports high-temperature steam to the surface of oil or grease to combine the water vapor with the odorous substances. Through the upward transpiration of the water vapor, the odorous substances escape from the grease, thereby deodorizing the oil.

Feedstock treatment processes may be performed after or immediately following an extraction process. For example, in the solvent extraction process, the final removal of solvent from the oil is achieved in the oil stripper. The feedstock treatment processes could be performed on the oil immediately following final removal of hexane in the oil stripper. Exemplary extraction processes include but are not limited to steam distillation, organic solvent extraction, and supercritical CO₂ fluid extraction methods, and molecular distillation techniques. Some products of extraction can contain an amount of wax components so large that their removal is necessitated, e.g., by dewaxing processes. For illustrative purposes, the waxes in essential oils are higher aliphatic hydrocarbons, which can increase the cloud point of essential oils, reduce transparency, hinder the volatilization of aroma components, and reduce overall quality.

Feedstock treatment processes may include water recycling loops to reduce the volume of water discharge and allow for autocatalyzing reactions. Water from decanters or other separators may be recycled back to mix with more uncleaned feedstock. The recycling loops may comprise high or low pressure recycled water. The recycled water may be fed back into the feedstock treatment process, further cleaned to create a cleaned water stream, or sent to a waste collection. The portion of water from the decanters partitioned to be recycled, to be further cleaned, or to go to waste may be controlled such that optimum contaminant levels in the water streams are reached.

Recycled water may have a low pH (acidic) and high phosphate levels, indicating that the recycled water comprises or is essentially phosphoric acid. By using highly acidic recycled water stream, the feedstock treatment process may not require the inclusion of an acid stream to catalyze the reactions that clean the feedstock. Acidic water may be particularly useful for hydrating phospholipids that are only moderately “hydratable” at neutral pH, such as Phosphatidylethanolamine. The feedstock and recycled water stream may be autocatalyzed without the introduction of acid.

The wastewater streams from the feedstock treatment process may be cleaned up and reclaimed to reduce the volume of water discharge. A wastewater evaporation process may be used to turn wastewater into steam. The evaporation process may comprise at least one, at least two, or at least three evaporators/heaters. The evaporators/heaters may utilize a thermocompressor.

Each evaporators/heater may heat the wastewater to a temperature above 100° C. to 160° C., turning a portion of the wastewater into steam. The steam may be released, reducing the volume of wastewater. Any residual wastewater may be discharged or further treated.

Energy usage for the evaporators may be offset by optimizing inlet conditions and availability/economization of waste heat. Further, the materials and operating conditions may be optimized for fouling and possible corrosion.

Referring to FIG. 1, the process 100 includes the step of providing feedstock 102. Optionally, the feedstock 102 may be stored in a storage tank 101. Optionally, the process includes the step of heating and pressurizing feedstock 102 to provide a heated and pressurized feedstock. A pump 103 may be provided for supplying feedstock 102. In certain embodiments feedstock 102 is heated to a temperature of up to about 250° C., alternatively between about 50° C. and 200° C., or alternatively between about 100° C. and 175° C. In certain other embodiments, feedstock 102 can be provided at a temperature as low as about 10° C. Preferably, the step of heating of the feedstock is limited, and the temperature to which the feedstock is heated is maintained as low as possible. Preferably the feedstock is provided at a temperature from about 30° C. to about 50° C., for example at 35° C. The feedstock 102 can be pressurized to a pressure of greater than atmospheric pressure, preferably at least about 5 MPa, alternatively greater than about 10 MPa, or alternatively greater than about 15 MPa.

In one embodiment, the process may also include providing water feed 104. A pump 105 may be provided for supplying water feed 104. In some embodiments the water feed 104 is heated to a temperature of greater than about 30° C., optionally between about 100° C. and 175° C., alternatively between about 50° C. and 75° C., or between about 20° C. and 50° C. In certain embodiments, water feed 104 is pressurized to a pressure of between about 1 MPa and 10 MPa, alternatively to a pressure of between about 1 MPa and 5 MPa.

The feedstock 102 and the water feed 104 are combined to form a combined feedstock and water stream 106. Feedstock 102 and water feed 104 can be combined by known means, such as for example, a valve, tee fitting or the like. The combined feedstock and water feed stream 106 is pressurized to a pressure of between about 1 MPa to 10 MPa, 3 MPa to 10 MPa, 3 MPa to 6 MPa, 2 MPa to 8 MPa, or alternatively to a pressure of between about 1 MPa and 5 MPa. Optionally, feedstock 102 and water feed 104 can be combined in a larger holding vessel (not shown) that is maintained at a temperature of from between about 200° C. and 300° C. and pressure of between to 2 MPa to 8 MPa. Optionally, the feedstock 102 and water feed 104 can be supplied to a larger vessel that includes mixing means, such as a mechanical stirrer, or the like. In certain embodiments, feedstock 102 and water feed 104 are thoroughly mixed at the point where they are combined. The mass ratio of feedstock 102 and water feed 104 can be between about 0:1 and 10:1, optionally between about 0:1 and 5:1, optionally between about 0:1 and 2:1, or optionally between about from 0:1 and 1:1.

Process 100 may optionally include adding an additive as described above to the feedstock prior to steam injection. The additive may be added to feedstock 102, water feed 104, and/or the combined feedstock and water stream 106.

The process further includes directly injecting steam 108 into the combined feedstock and water stream 106. The steam 108 may be provided at a pressure of from 1 MPa to 10MPa, 3 MPa to 10MPa, 3 MPa to 7 MPa, 5 MPa to 10 MPa, or from 5 MPa to 8 MPa, or alternatively, at about 6 MPa. The direct steam injection 108 accomplishes heat transfer to the combined feedstock and water feed stream 106 traveling through the pipeline and forming the heated combined feedstock and water feed stream 110. The combined feedstock and water stream 106 is heated upon contact with steam 108 that is directly injected into the combined feedstock and water stream 106. Upon injection, the steam mixes with the combined feedstock and water stream 106. Further, the combined feedstock and water stream 106 is heated by the condensation of steam 108.

The mass ratio of steam 108 to combined feedstock and water feed 106 can be between about 0.1:10 and 10:0.1, optionally between about 0.1:5 and 5:0.1, optionally between about 0.1:1 and 0.4:1.

The ratio of water to feedstock in the combined feedstock and water 106 includes the steam injected and condensed and added by water feed 104.

The temperature of the heated and pressurized combined feedstock and water feed stream 110 may be from 50° C. to 280° C., optionally between about 80° C. and 200° C., alternatively between about 90° C. and 180° C., or between about 100° C. and 150° C.

The heated combined feedstock and water feed stream 110 is supplied to a hydrothermal reactor 112. Hydrothermal reactor 112 can be a known type of reactor, such as, a tubular type reactor, vessel type reactor, optionally equipped with stirrer, or the like. Hydrothermal reactor 112 can be horizontal, vertical or a combined reactor having horizontal and vertical reaction zones. Hydrothermal reactor 112 preferably does not include a solid catalyst. Hydrothermal reactor 112 can include one or more heating or cooling devices, such as for example, an immersion exchanger, tubular furnace, or the like, as known in the art, heating the incoming stream 110 further to a temperature of from 200° C. and 370° C.

The temperature of hydrothermal reactor 112 can be between about 200° C. to 370° C., optionally between about 250° C. to 350° C., or optionally between about 220° C. to 250° C. The residence time of heated and pressurized combined feed stream 110 in the hydrothermal reactor 112 can be between about 1 second to 120 minutes, optionally between about 5 seconds to 5 minutes, optionally between about 1 to 3 minutes, optionally between about 30 to 60 seconds, optionally between about 1 minutes to 60 minutes, optionally between about 2 minutes to 30 minutes, optionally between about 5 minutes to 15 minutes, or optionally between about 10 seconds to 10 minutes, where each range is inclusive. The residence time in the reactor is sufficient such that some contaminants are liberated from the feedstock

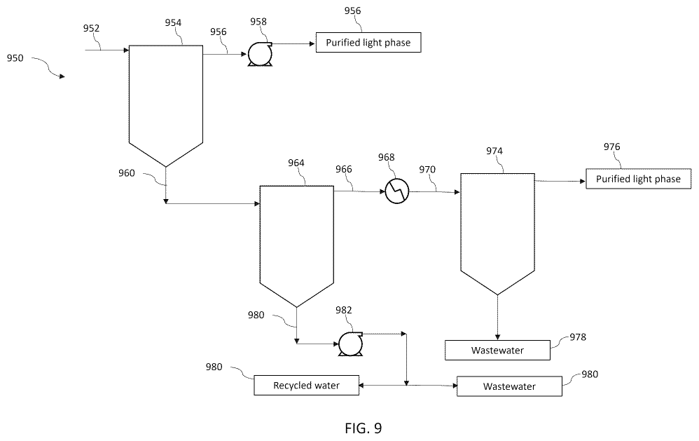

Hydrothermal reactor 112 produces a product stream 114. In one embodiment, product stream 114 may be provided to a multi-separation process, such as process 950 in FIG. 9, to separate the water from the feedstock product.

In another embodiment, product stream 114 may be cooled in a heat exchanger 116, yielding a cooled product stream 118, which then passes through a pressure control valve or backpressure regulator 120 that maintains system pressure. Depressurized product stream 122 is further cooled as necessary, for examples by a further cooling heat exchanger (not shown). The temperature of the partially cooled product stream 118 may be about 90° C. or less, such as a temperature of from 40° C. and 80° C. The cooled product stream 122 is then fed to a separator 124. Additional compounds maybe be added to separator 124 to facilitate or improve phase separation or phase boundary. Such separation aids are known in the art.

Treated or cleaned feedstock 126 and process water stream 128 are removed from the separator 124. It can be appreciated that following separation 124 the treated or cleaned feedstock 126 may be subjected to subsequent separations and purifications including of one or more vapor-liquid separation unit operations including single-stage flash, rectification, stripping, centrifuging, water washing or distillation where the configuration and operation are dependent on the feedstock and product cleanup requirements. Optionally, the treated or cleaned feedstock may be stored in a treated feedstock storage tank 130.

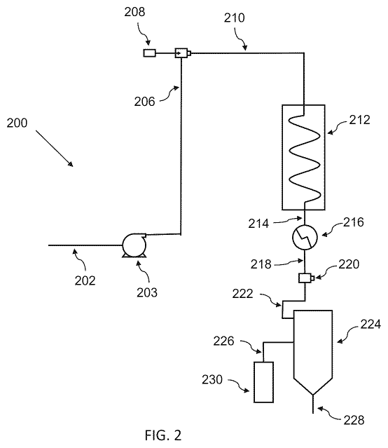

In an alternative embodiment, and referring to FIG. 2, the process 200 includes providing feedstock 202. Optionally, the feedstock 202 may be stored in a storage tank. Optionally, the process includes the step of heating and pressurizing feedstock 202 to provide a heated and pressurized feedstock. A pump 203 may be provided for supplying feedstock 202. In certain embodiments feedstock 202 is heated to a temperature of up to about 250° C., alternatively between about 50 and 200° C., or alternatively between about 100 and 175° C. In certain other embodiments, feedstock 202 can be provided at a temperature as low as about 10° C. Preferably, the step of heating of the feedstock is limited, and the temperature to which the feedstock is heated is maintained as low as possible. Preferably the feedstock is provided at a temperature from about 30° C. to about 50° C., for example at 35° C. The feedstock 202 can be pressurized to a pressure of greater than atmospheric pressure, preferably at least about 3 MPa, alternatively at least about 5 MPa, alternatively greater than about 10 MPa, or alternatively greater than about 15 MPa to form pressurized feedstock 206. In other examples, pressurized feedstock 206 may be at least about 3 MPa but does not exceed about 10 MPa, 20 MPa, or 30 MPa.

The process 200 further includes directly injecting steam 208 into the pressurized feedstock 206. The steam 208 may be provided at a pressure of from 1 MPa to 10 MPa, 3 MPa to 10 MPa, 3 MPa to 7 MPa, 5 MPa to 10 MPa, or from 5 MPa to 8 MPa, or alternatively, at about 6 MPa. The direct steam injection 208 accomplishes heat transfer to the pressurized feedstock 206 traveling through the pipeline and the formation of a combined feedstock and water stream 210. The pressurized feedstock 206 is heated upon contact with steam 208 that is directly injected into the pressurized feedstock 206. Upon injection, the steam mixes with the pressurized feedstock 206, which further results in condensation of the steam 208, which thus provides the water for forming the combined feedstock and water stream 210.

The mass ratio of steam 208 to feedstock 206 can be between about 0.1:10 and 10:0.1, optionally between about 0.1:5 and 5:0.1, optionally between about 0.1:1 and 0.4:1.

The ratio of water to feedstock in stream 210 depends on the steam injected and amount condensed. For example, if the desired water to feedstock ratio is 0.5, and the desired temperature after direct steam injection is 200° C.

The temperature of the heated feedstock and water stream 210 may be from 50° C. to 280° C., from 250° C. to 275° C., optionally between about 80° C. and 200° C., alternatively between about 90° C. and 180° C., or between about 100° C. and 150° C. Alternatively, the temperature of the heated and pressurized combined feedstock and water stream may be greater than or equal to 200° C. but less than or equal to 260° C., such as 200-260° C., 220-260° C., 230-260° C., 240-260° C., 210-250° C., or 220-250° C., inclusive.

The combined feedstock and water stream 210 may then be processed further as is described in detail with respect to FIG. 2. For example, the combined feedstock and water stream 210 may be supplied to a hydrothermal reactor 212, yielding a product stream 214.

In one embodiment, product stream 214 may be provided to a multi-separation process, such as process 950 in FIG. 9, to separate the water from the feedstock product.

In another embodiment, product stream 214 may be cooled in a heat exchanger 216, yielding a cooled product stream 218, which then passes through a pressure control valve or backpressure regulator 220 that maintains system pressure. Depressurized product stream 222 is further cooled as necessary and supplied to a separator 224. Treated or cleaned feedstock 226 and process water stream 228 are removed from the separator 224. It can be appreciated that following separation 224 the treated or cleaned feedstock 226 may be subjected to subsequent separations and purifications including of one or more vapor-liquid separation unit operations including single-stage flash, rectification, stripping, centrifuging, water washing or distillation where the configuration and operation are dependent on the feedstock and product cleanup requirements. Optionally, the treated or cleaned feedstock may be stored in a treated feedstock storage tank 230.

The hydrothermal feedstock treatment process operated as described above dissociates inorganic contaminants (e.g., salts, minerals, and/or metals) which partition into the process water stream 228 and greater than 95%, for example from 95% to 99% of the contaminants are eliminated from the contaminated feedstock 202.

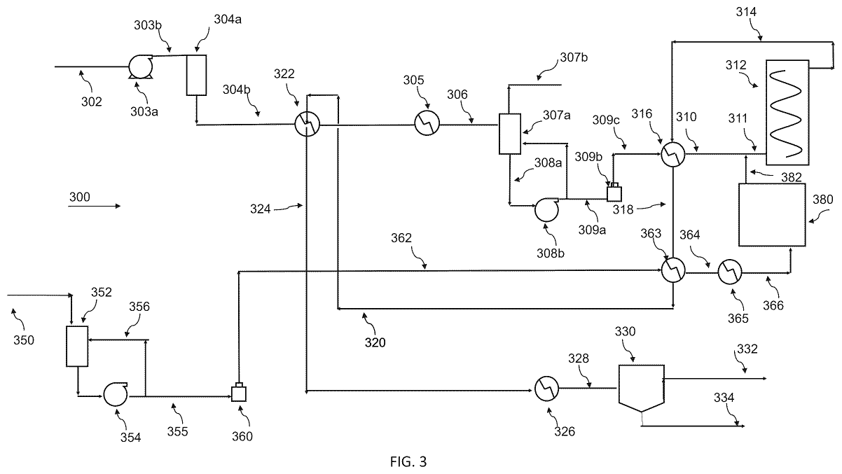

In an alternative embodiment, and referring to FIG. 3, the process 300 includes providing feedstock 302. The feedstock 302 may be degummed as described herein. Optionally the feedstock 302 may be provided from a storage tank (not shown). Optionally, the process includes the step of heating and pressurizing feedstock 302 to provide a heated and pressurized feedstock 303b. A pump 303a may be provided for supplying pressurized feedstock 303b. For example, the feedstock 302 can be pressurized to a pressure of greater than atmospheric pressure, preferably at least about 3 MPa, alternatively at least about 5 MPa, alternatively greater than about 10 MPa, or alternatively greater than about 15 MPa. In other examples, the feedstock pressure may be at least about 3 MPa but does not exceed about 10 MPa, 20 MPa, or 30 MPa. The pressurized feedstock 303b may be passed through a feed filter 304a, forming a filtered feedstock 304b.

Process 300 may optionally include adding an additive as described above to the feedstock prior to steam injection. The additive may be added to feedstock 302 and/or filtered feedstock 304b.

Optionally, the filtered feedstock 304b may be passed through a heat exchanger 322 allowing for heat exchange with a pre-cooled reactor effluent 320, which exits the heat exchanger 322 as product stream 324. Optionally, the filtered feedstock 304b may further be heated in a feed heater 305, thereby producing a heated feedstock 306. Heated feedstock 306 may be supplied to a deaerator 307a. Gases, such as for example air, oxygen and carbon dioxide, may exit the deaerator 307a as gas stream 307b. Optionally, gas stream 307b is supplied to a vacuum system, captured, stored or further processed.

A degassed feedstock stream 308a exits on the bottom the deaerator 307a. The degassed feed stock stream 308a may optionally be pressurized via pump 308b forming a pressurized degassed feedstock stream 309a. Pump 308b may recycle pressurized degassed feedstock stream 309a to a deaerator 307a, or send pressurized degassed feedstock stream 309a to a pump 309b to further pressurize the stream forming a reactor supply stream 309c. Reactor supply stream 309c may be preheated in heat exchanger 316 forming a heated reactor supply stream 310 by exchanging heat with reactor effluent stream 314, which exits the heat exchanger 316 as a cooled reactor effluent 318.

Water is supplied to the process 300 by a water feed 350, optionally from storage in a water tank 352, and pumped through an RO water pump 354 forming water stream 355. Recycled water 356 may be returned to the water tank 352. The water stream 355 may be supplied to the process 300 via a water pump 360 as a pressurized water stream 362. Optionally, the pressurized water stream 362 may be preheated in heat exchanger 363 forming a heated water supply stream 364 by exchanging heat with cooled reactor effluent 318, which exits the heat exchanger 363 as a further cooled reactor effluent 320. The heated water supply stream 364 may further be heated by boiler feed heater 365 forming a heated boiler feed 366. The heated boiler feed 366 is supplied to steam generator 380, producing steam feed 382.

The process 300 further includes directly injecting steam feed 382 into heated reactor supply stream 310, forming reactor supply 311. The steam feed 382 may be provided at a pressure of from 1 MPa to 10 MPa, 3 MPa to 10 MPa, 3 MPa to 7 MPa, 5 MPa to 10 MPa, or from 5 MPa to 8 MPa, or alternatively, at about 6 MPa. The direct steam injection 382 accomplishes heat transfer to the heated reactor supply stream 310 traveling through the pipeline and forming reactor supply 311. The reactor supply 310 is heated upon contact with steam 382 that is directly injected. Upon injection, the steam mixes with the heated reactor supply 310, which further results in condensation of the steam 382, which thus provides the water for forming the forming the reactor supply 311, which thus may also be referred to as a combined feedstock and water stream 311.

The mass ratio of steam 392 to feed stock in stream 311 can be between about 0.1:10 and 10:0.1, optionally between about 0.1:5 and 5:0.1, optionally between about 0.1:1 and 0.4:1.

The ratio of water to feedstock in stream 311 depends on the steam injected and amount condensed. For example, if the desired water to feedstock ratio is 0.5, and the desired temperature after direct steam injection is 200° C.

The temperature of the combined feedstock and water stream 311 may be from 50° C. to 280° C., from 250° C. to 275° C., optionally between about 80° C. and 200° C., alternatively between about 90° C. and 180° C., or between about 100° C. and 150° C.

The temperature of the cooled reactor effluent 318 may be about 90° C. or less, 80° C. or less, or a temperature of from 40° C. and 80° C.

The combined feedstock and water stream 311 is supplied to a hydrothermal reactor 312. The reaction temperature in the hydrothermal reactor 312 may be from 50° C. to 280° C., from 150° C. to 280° C., from 180° C. to 260° C. from 190° C. to 280° C. from 200° C. to 280° C., from 250° C. to 275° C., optionally between about 80° C. and 200° C., alternatively between about 90° C. and 180° C., or between about 100 and 150° C. The reaction temperature in the hydrothermal reactor 312 may exceed 250° C. For example, the reaction temperature may range from 250° C. to 280° C., 250° C. to 275° C., 250° C. to 270° C., 250° C. to 265° C., 250° C. to 260° C., or 250° C. to 255° C., where each range is inclusive.

The residence time of combined feedstock and water stream 311 in the hydrothermal reactor 312 can be between about 1 second to 120 minutes, optionally between about 5 seconds to 5 minutes, optionally between about 1 to 3 minutes, optionally between about 30 to 60 seconds, optionally between about 1 minutes to 60 minutes, optionally between about 2 minutes to 30 minutes, optionally between about 5 minutes to 15 minutes, or optionally between about 10 seconds to 10 minutes, where each range is inclusive. The residence time in the reactor is sufficient such that some contaminants are liberated from the feedstock.

As noted, the reactor effluent stream 314 exits the hydrothermal reactor 312. In one embodiment, reactor effluent stream 314 may be provided to a multi-separation process, such as process 950 in FIG. 9, to separate the water from the feedstock product.

In another embodiment, reactor effluent stream 314 may optionally be cooled, as described above, via various heat exchangers. As cooling the product stream in this manner makes the process more economical, the heat exchangers may also be referred to as economizer. Optionally, the system may include a pressure control valve or backpressure regulator that maintains system pressure as necessary. Product stream 324 may be further cooled in product cooler 326 as necessary and cooled product stream 328 may be supplied to a separator 330. Treated or cleaned feedstock 334 and process water stream 332 are removed from the separator 330. It can be appreciated that following separation 330 the treated or cleaned feedstock 334 may be subjected to subsequent separations and purifications including of one or more vapor-liquid separation unit operations including single-stage flash, rectification, stripping, centrifuging, water washing or distillation where the configuration and operation are dependent on the feedstock and product cleanup requirements. Optionally, the treated or cleaned feedstock may be stored in a treated feedstock storage tank.

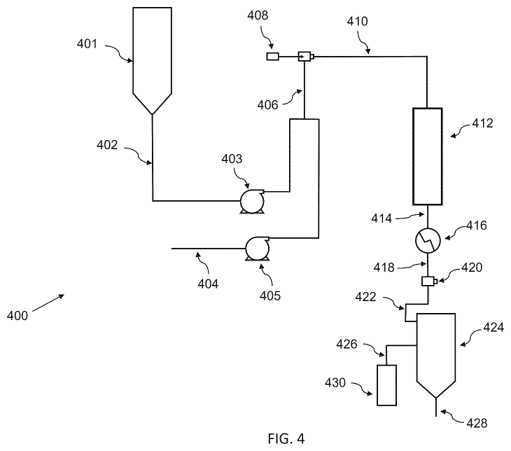

In an alternative embodiment, and referring to FIG. 4, the process 400 includes the step of providing feedstock 402. Optionally, the feedstock 402 may be stored in a storage tank 401. Optionally, the process includes the step of heating and pressurizing feedstock 402 to provide a heated and pressurized feedstock. A pump 403 may be provided for supplying feedstock 402. In certain embodiments feedstock 402 is heated to a temperature of up to about 250° C., alternatively between about 50° C. and 200° C., or alternatively between about 100 and 175° C. In certain other embodiments, feedstock 402 can be provided at a temperature as low as about 10° C. Preferably, the step of heating of the feedstock is limited, and the temperature to which the feedstock is heated is maintained as low as possible. Preferably the feedstock is provided at a temperature from about 30° C. to about 50° C., for example at 35° C. The feedstock 402 can be pressurized to a pressure of greater than atmospheric pressure, preferably at least about 5 MPa, alternatively greater than about 10 MPa, or alternatively greater than about 15 MPa.

In one embodiment, the process may also include providing water feed 404. A pump 405 may be provided for supplying water feed 404. In some embodiments the water feed 404 is heated to a temperature of greater than about 30° C., optionally between about 100° C. and 175° C., alternatively between about 50° C. and 75° C., or between about 20° C. and 50° C. In certain embodiments, water feed 404 is pressurized to a pressure of between about 1 MPa and 10 MPa, alternatively to a pressure of between about 1 MPa and 5 MPa.

The feedstock 402 and the water feed 404 are combined to form a combined feedstock and water stream 406. Feedstock 402 and water feed 404 can be combined by known means, such as for example, a valve, tee fitting or the like. The combined feedstock and water feed stream 406 is pressurized to a pressure of between about 1 MPa to 10 MPa, 3 MPa to 10 MPa, 3 MPa to 6 MPa, 2 MPa to 8 MPa, or alternatively to a pressure of between about 1 MPa and 5 MPa. Optionally, feedstock 402 and water feed 404 can be combined in a larger holding vessel (not shown) that is maintained at a temperature of from between about 200° C. and 300° C. and pressure of between to 2 MPa to 8 MPa. Optionally, the feedstock 402 and water feed 404 can be supplied to a larger vessel that includes mixing means, such as a mechanical stirrer, or the like.

Process 400 may optionally include adding an additive as described above to the feedstock prior to steam injection. The additive may be added to feedstock 402 prior to heating/pressurizing by pump 403, feedstock 402 after heating/pressurizing by pump 403, water feed 404, and/or the combined feedstock and water stream 406.

In certain embodiments, feedstock 402 and water feed 404 are thoroughly mixed at the point where they are combined. The mass ratio of feedstock 402 and water feed 404 can be between about 0:1 and 10:1, optionally between about 0:1 and 5:1, optionally between about 0:1 and 2:1, or optionally between about from 0:1 and 1:1.

The process further includes directly injecting steam 408 into the combined feedstock and water stream 406. The steam 408 may be provided at a pressure of from 1 MPa to 10 MPa, 3 MPa to 10 MPa, 3 MPa to 7 MPa, 5 MPa to 10 MPa, or from 5 MPa to 8 MPa, or alternatively, at about 6 MPa. The direct steam injection 408 accomplishes heat transfer to the combined feedstock and water feed stream 406 traveling through the pipeline and forming the heated combined feedstock and water feed stream 410. The combined feedstock and water stream 406 is heated upon contact with steam 408 that is directly injected into the combined feedstock and water stream 406. Upon injection, the steam mixes with the combined feedstock and water stream 406. Further, the combined feedstock and water stream 406 is heated by the condensation of steam 408.

The mass ratio of steam 408 to combined feedstock and water feed 406 can be between about 0.1:10 and 10:0.1, optionally between about 0.1:5 and 5:0.1, optionally between about 0.1:1 and 0.4:1.

The ratio of water to feedstock in the combined feedstock and water 406 includes the steam injected and condensed and added by water feed 404.

The temperature of the heated and pressurized combined feedstock and water feed stream 410 may be from 50° C. to 280° C., optionally between about 80° C. and 200° C., alternatively between about 90 and 180° C., or between about 100 and 150° C. Alternatively, the temperature of the heated and pressurized combined feedstock and water feed stream may be greater than or equal to 200° C. but less than or equal to 260° C., such as 200-260° C., 220-260° C., 230-260° C., 240-260° C., 210-250° C., or 220-250° C., inclusive.

The heated combined feedstock and water feed stream 410 is supplied to a pipe 412. The flow within the pipe may be characterized by a Reynolds number of less than about 2300, 2000, 1750, or 1500. In other examples, the laminar flow may have a Reynolds number of from 50 to 750, 75 to 1750, 100 to 1650, 250 to 1500, 500 to 2000, 750 to 2000, 1000 to 2000, 500 to 1000, 750 to 1250, 1250 to 1800, or 1500 to 2000, wherein each range is inclusive.

The pipe 412 can be made of stainless steel or a specialized corrosion-resistant material. The pipe 412 may further include an inert liner, such as an inert liner including polytetrafluoroethylene or polypropylene. One or more heating devices may be used to heat the incoming stream 410, such as for example, a strip heater, immersion heater, tubular furnace, electrical heat tracing cables, steam tracing, a fired heater, an electrical induction system, a hot oil or thermal fluid heating system, or the like, as known in the art, The incoming stream 410 may be heated to a temperature of from 200° C. and 370° C.

The temperature maintained in the pipe 412 can be between about 200° C. to 370° C., optionally between about 250° C. to 350° C., or optionally between about 220° C. to 250° C. The residence time of heated and pressurized combined feed stream 410 in the pipe 412 can be between about 1 second to 120 minutes, optionally between about 5 seconds to 5 minutes, optionally between about 1 to 3 minutes, optionally between about 30 to 60 seconds, optionally between about 1 minutes to 60 minutes, optionally between about 2 minutes to 30 minutes, optionally between about 5 minutes to 15 minutes, or optionally between about 10 seconds to 10 minutes, where each range is inclusive. The residence time in the reactor is sufficient such that some contaminants are liberated from the feedstock.

The pipe 412 produces a product stream 414. In one embodiment, product stream 414 may be provided to a multi-separation process, such as process 950 in FIG. 9, to separate the water from the feedstock product.

In another embodiment, product stream 414 may proceed to be cooled in a heat exchanger 416, yielding a cooled product stream 418, which then passes through a pressure control valve or backpressure regulator 420 that maintains system pressure. Depressurized product stream 422 is further cooled as necessary, for examples by a further cooling heat exchanger (not shown). The temperature of the partially cooled product stream 418 may be about 90° C. or less, a temperature of from 40° C. and 80° C. The cooled product stream 422 is then fed to a separator 424. Additional compounds maybe be added to separator 424 to facilitate or improve phase separation or phase boundary. Such separation aids are known in the art.

Treated or cleaned feedstock 426 and process water stream 428 are removed from the separator 424. It can be appreciated that following separation 424 the treated or cleaned feedstock 426 may be subjected to subsequent separations and purifications including of one or more vapor-liquid separation unit operations including single-stage flash, rectification, stripping, centrifuging, water washing or distillation where the configuration and operation are dependent on the feedstock and product cleanup requirements. Optionally, the treated or cleaned feedstock may be stored in a treated feedstock storage tank 430.

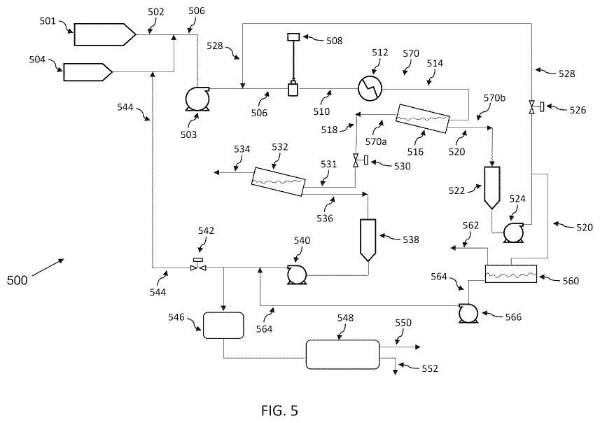

Referring to FIG. 5, an embodiment of a water recycling process 500 is shown. Water recycling process 500, may be incorporated into any of processes 100, 200, 300, and 400. A water recycling loops 570 may comprise at least two water recycling paths 570a, 570b defined by the following process that results in recycled water streams 528, 544 and clean water 550. Water recycling loops 570 may be combined within processes 100, 200, 300, and 400 after heat exchanger 116, 216, 316, or 416 such that cooled product stream 118, 218, 318, 418 flow into water recycling loops 570 to continue the process of cleaning the feedstock while recycling water. The following description generally describes one potential embodiment of the water recycling process. A person of ordinary skill in the art would understand that water recycling loops 570 may be used in other processes as described above.

Process 500 includes the step of providing feedstock 502. Optionally, the feedstock 502 may be stored in a storage tank 501. The process 500 may also include providing a water feed 504. A pump may be provided for supplying water feed 504.

The feedstock 502 and the water feed 504 are combined to form a combined feedstock and water stream 506. Feedstock 502 and water feed 504 can be combined by known means, such as for example, a valve, tee fitting or the like. A pump 503 may be provided for supplying feedstock and water stream 505 downstream of process 500.

Process 500 may optionally include adding an additive as described above to the feedstock prior to steam injection. The additive may be added to feedstock 502, water feed 504, and/or the combined feedstock and water stream 506.

The combined feedstock and water stream 506 is pressurized to a pressure of between about 1 MPa to 10 MPa, 3 MPa to 10 MPa, 3 MPa to 6 MPa, 2 MPa to 8 MPa, or alternatively to a pressure of between about 1 MPa and 5 MPa. Optionally, feedstock 502 and water feed 504 can be combined in a larger holding vessel (not shown) that is maintained at a temperature of from between about 200° C. and 300° C. and pressure of between to 2 MPa to 8 MPa. Optionally, the feedstock 502 and water feed 504 can be supplied to a larger vessel that includes mixing means, such as a mechanical stirrer, or the like. In certain embodiments, feedstock 502 and water feed 504 are thoroughly mixed at the point where they are combined. The mass ratio of feedstock 502 and water feed 504 can be between about 0:1 and 10:1, optionally between about 0:1 and 5:1, optionally between about 0:1 and 2:1, or optionally between about from 0:1 and 1:1.

The process further includes directly injecting steam 508 into the combined feedstock and water stream 506. The steam 508 may be provided at a pressure of from 1 MPa to 10 MPa, 3 MPa to 10 MPa, 3 MPa to 7 MPa, 5 MPa to 10 MPa, or from 5 MPa to 8 MPa, or alternatively, at about 6 MPa. The direct steam injection 508 accomplishes heat transfer to the combined feedstock and water feed stream 506 traveling through the pipeline and forming the heated and pressurized combined feedstock and water stream 510. The combined feedstock and water stream 506 is heated upon contact with steam 508 that is directly injected into the combined feedstock and water stream 506. Upon injection, the steam mixes with the combined feedstock and water stream 506. Further, the combined feedstock and water stream 506 is heated by the condensation of steam 508.

The mass ratio of steam 508 to combined feedstock and water feed 506 can be between about 0.1:10 and 10:0.1, optionally between about 0.1:5 and 5:0.1, optionally between about 0.1:1 and 0.4:1.

The ratio of water to feedstock in the combined feedstock and water 506 includes the steam injected and condensed and added by water feed 504.

The temperature of the heated and pressurized combined feedstock and water stream 510 may be from 200° C. to 300° C., optionally between about 220° C. and 280° C., alternatively between about 240° C. and 260° C., or between about 255° C. and 260° C.

In one embodiment, heated and pressurized combined feedstock and water stream 510 may be provided to a multi-separation process, such as process 950 in FIG. 9, to separate the water from the feedstock product.

In another embodiment, the heated and pressurized combined feedstock and water stream 510 may be optionally passed through a heat exchanger 512 allowing for heat exchange with a pre-cooled reactor effluent to form a cooled feedstock and water stream 514.

The cooled feedstock and water stream 514 exits heat exchanger 512 and enters a high-pressure decanter 516 to separate feedstock 518 from high-pressure water 520. High pressure water 520 may be at a pressure above 3 MPa to 6 MPa. High-pressure water 520 may be held in a storage tank 522. Pump 524 may help supply high pressure water 520 from storage tank 522 to a flow control valve 526 to provide a high pressure water stream 528. High pressure water stream 528 may be recycled back to feedstock and water stream 506 preceding steam injection 508. High pressure water stream 528 may mix with feedstock and water stream 506 via any conventional mixing such that high pressure water stream 528 is completely incorporated into feedstock and water stream 506. Additionally, or alternatively, high pressure water stream 528 may be recycled to another process, such as a pretreatment process (discussed further below).

Feedstock 518 leaves the high-pressure decanter 516 and enters a pressure control valve 530 configured to reduce the pressure of feedstock 518. Low pressure feedstock 531 exits pressure control valve 530 and enters a liquid-liquid separator, such as low pressure decanter 532 or other operation such as an evaporator. Low pressure decanter 532 separates low pressure feedstock 531 into treated feedstock 534 and any remaining water stream 536. The remaining water stream may be at a pressure of 0 MPa to 2 MPa. Treated or cleaned feedstock 534 is removed from low pressure decanter 532. Optionally, or alternatively, treated feedstock 534 may be fed into an evaporator. It can be appreciated that following separation in low pressure decanter 532 and/or evaporation, the treated or cleaned feedstock 534 may be subjected to subsequent separations and purifications including of one or more vapor-liquid separation unit operations including single-stage flash, rectification, stripping, centrifuging, water washing or distillation where the configuration and operation are dependent on the feedstock and product cleanup requirements. Optionally, the treated or cleaned feedstock may be stored in a treated feedstock storage tank.

The remaining water stream 536 may be stored in a water storage tank 538. Pump 540 may help supply water stream 536 from water storage tank 538 to a flow control valve 542. Flow control valve 542 may control the flow of the water stream 536 such that water stream 544 exits the flow control valve 542 at a moderated pace/volume. Water stream 544 may be recycled back to water feed 504. Water stream 544 may mix with water stream 504 via any conventional mixing such that low pressure water 544 is completely incorporated into water stream 504. Additionally, or alternatively, Water stream 544 may be recycled to another process, such as a pretreatment process (discussed further below).

Additionally, pump 540 may supply water stream 536 from storage tank 538 to a second water storage tank 546. From second water storage tank 546, water stream 536 may supplied to an evaporator 548. Alternatively, the process may include a heater in place of evaporator 548. The evaporator may include a multi-effect evaporator (MEE), single-effect evaporator or a flash evaporator. Multi-effect evaporator/heater 548 may heat the water stream 536 such that water stream 536 separates into heavier water contaminants 552 and clean water/steam 550. Clean water/steam 550 may exit the multi-effect evaporator/heater and be released, stored, or used in other processes, such as a pretreatment process (discussed further below). Contaminants 552 may be expelled from multi-effect evaporator/heater 548 and stored in a waste tank or otherwise disposed of.

Additionally, from storage tank 522, discussed above, pump 524 may supply high-pressure water 520 to a flash tank 560 configured to flash heat high pressure water stream 520, turning some of water 520 into steam 562. Steam 562 exits flash tank 560 and may be released, stored, or used in other processes. Any residual water 564 that did not evaporate may exit flash tank 560 and be recycled to combine with water stream 536 downstream of pump 540 such that the combined water stream 536 and residual water 564 may enter either flow control valve 542 or second water tank 546, as described above.

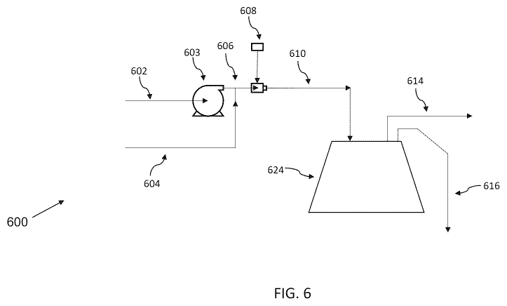

Referring to FIG. 6, pretreatment process using a degumming or water washing process 600 is provided. Process 600 may degum and/or wash feedstock 101/102/202/302/401/402/501 preceding any of processes 100, 200, 300, 400, and 500. Unwashed feedstock 602 may be provided. A pump 603 may be provided for supplying unwashed feedstock 602. In certain embodiments unwashed feedstock 602 is heated to a temperature of up to about 100° C., alternatively between about 40 and 80° C., or alternatively between about 50° C. and 70° C. Preferably the feedstock is provided at a temperature from about 55° C. to about 65° C., for example at 62° C. The unwashed feedstock 602 can be pressurized to a pressure of greater than atmospheric pressure, preferably at least about 5 MPa, alternatively greater than about 10 MPa, or alternatively greater than about 15 MPa.

The process may also include providing a degumming agent feed 604. The process may include water degumming, as described above, in which case, degumming agent feed 604 may comprise water. The process may include acid degumming, as described above, in which case degumming agent feed 604 may comprise an acid, of which the acid may comprise phosphoric acid (referring to the acidic water produced as discussed above. A pump may be provided for supplying degumming agent feed 604. In some embodiments the degumming agent feed 604 is heated to a temperature of greater than about 30° C., optionally between about 100° C. and 175° C., alternatively between about 50° C. and 75° C., or between about 20 and 50° C. In certain embodiments, degumming agent feed 604 is pressurized to a pressure of between about 1 MPa and 10 MPa, alternatively to a pressure of between about 1 MPa and 5 MPa.

The unwashed feedstock 602 and the degumming agent feed 604 are combined to form a combined feedstock and degumming agent stream 606. Unwashed feedstock 602 and degumming agent feed 604 can be combined by known means, such as for example, a valve, tee fitting or the like. The combined feedstock and degumming agent stream 606 is pressurized to a pressure of between about 1 to 10 MPa, 3 MPa to 10 MPa, 3 MPa to 6 MPa, 2 MPa to 8 MPa, or alternatively to a pressure of between about 1 MPa and 5 MPa. Optionally, unwashed feedstock 602 and degumming agent feed 604 can be combined in a larger holding vessel (not shown) that is maintained at a temperature of from between about 200° C. and 300° C. and pressure of between to 2 MPa to 8 MPa. Optionally, the unwashed feedstock 602 and degumming agent feed 604 can be supplied to a larger vessel that includes mixing means, such as a mechanical stirrer, or the like. In certain embodiments, unwashed feedstock 602 and degumming agent feed 604 are thoroughly mixed at the point where they are combined. The mass ratio of unwashed feedstock 602 and degumming agent feed 604 can be between about 0:1 and 10:1, optionally between about 0:1 and 5:1, optionally between about 0:1 and 2:1, or optionally between about from 0:1 and 1:1.

Optionally, an additive as described above, such as a chemical additive, may be added into feedstock 602, degumming agent feed 604, or combined feedstock and degumming agent stream 606, prior to steam injection.

The process further includes optionally directly injecting steam 608 into the combined feedstock and degumming agent stream 606. The steam 608 may be provided at a pressure of from 0.05 MPa to 5 MPa, 0.5 MPa to 1.5 MPa, or from 1 MPa to 1.05 MPa. The direct steam injection 608 accomplishes heat transfer to the combined feedstock and degumming agent feed stream 606 traveling through the pipeline and forming the heated combined feedstock and degumming agent feed stream 610. The combined feedstock and water stream 606 is heated upon contact with steam 608 that is directly injected into the combined feedstock and degumming agent stream 606. Upon injection, the steam mixes with the combined feedstock and degumming agent stream 606. Further, the combined feedstock and degumming agent stream 606 is heated by the condensation of steam 608.

The mass ratio of steam 608 to combined feedstock and degumming feed 606 can be between about 100:1 to 50:1, optionally between 1:50 to 1:66.

The temperature of the heated and pressurized combined feedstock and degumming agent feed stream 610 may be from 50° C. to 100° C., optionally between about 60° C. and 90° C., alternatively between about 70° C. and 90° C., or between about 82° C. and 88° C.

The heated combined feedstock and degumming agent feed stream 610 is supplied to a separator 624. Separator 624 can be a known type of separator, such as, a centrifugal separator, a gravity phase separator, and electrostatic precipitation separator. Separator 624 may separate the feedstock from heavy phase gums.

Degummed feedstock 614 and heavy phase gums 616 are each removed from the separator 624. Degummed feedstock 614 may be subsequently used in processes 100, 200, 300, 400, 500, described above.

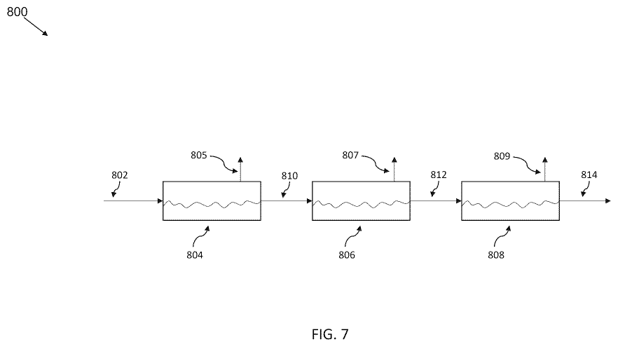

Following processes 100, 200, 300, 400, and 500 described above, and multi-separation process 950 described below, processed water 128, 228, 332, 428, 550, 980 may be reclaimed to reduce water discharge. Processed water 128, 228, 332, 428, 550, 980 may be supplied to water cleanup process 800, as shown in FIG. 7. Water cleanup process 800 may comprise supplying processed water 128, 228, 332, 428, 550, 980 (hereinafter “processed water 802”) to at least one evaporator/heater. In one embodiment, the at least one evaporator/heater may comprise a single evaporator/heater. The single evaporator/heater may operate as described in reference to evaporator/heater 804 below. In another embodiment, the at least one evaporator/heater may comprise a plurality of multi-effect evaporators/heaters 804, 806, 808. The plurality of multi-effect evaporators/heaters 804, 806, 808 may comprise a first multi-effect evaporator/heater 804, a second multi-effect evaporator/heater 806, and a third multi-effect evaporator/heater 808. Each of the plurality of multi-effect evaporators/heaters 804, 806, 808 may heat the processed water 802 such that steam 805, 807, 809 is released. The steam 805, 807, 809 may be captured, stored, and/or further processed.

Processed water 802 enters first multi-effect evaporator/heater 804. First multi-effect evaporator/heater 804 heats processed water 802 to a temperature between 120° C. to 160° C. A portion of processed water 802 may be turned into steam 805 and exits first multi-effect evaporator/heater 804. Optionally, steam 805 may be used to preheat processed water 802 to reclaim evaporative energy and condense the steam in 805. Remaining water 810 exits first multi-effect evaporator/heater 804 and enters second multi-effect evaporator/heater 806. Second multi-effect evaporator/heater 806 heats water 810 to a temperature between 110° C. to 150° C. A portion of water 810 may be turned into steam 807 and exits second multi-effect evaporator/heater 806. Remaining water 812 exits second multi-effect evaporator/heater 806 and enters third multi-effect evaporator/heater 808. Third multi-effect evaporator/heater 808 heats water 812 to a temperature between 100° C. to 140° C. A portion of water 812 may be turned into steam 809 and exits third multi-effect evaporator/heater 808. Remaining water 814 may exit third multi-effect evaporator and be stored in a storage tank, further processed or recycled, or otherwise disposed of. During process 800, the volume of remaining water 814 may be less than the volume of processed water 802 initially supplied to process 800.

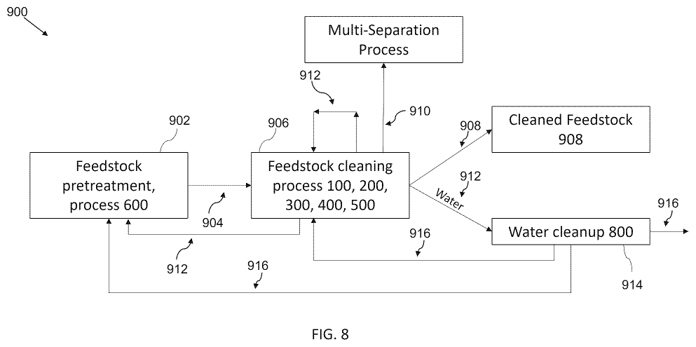

Referring to FIG. 8, degumming process 600 and water reclaiming process 800 may be used in combination with any of processes 100, 200, 300, 400, and 500 alone or in combination with each other. An exemplary flowchart 900 shows the synergy between the processes of the present disclosure. For example, feedstock may be pretreated using process 600 in step 902, creating pretreated feedstock 904. Pretreated feedstock 904 may be used in at least one of cleaning processes 100, 200, 300, 400, and 500 in step 906, forming cleaned feedstock 908 and water 912.

Prior to cooling and depressurizing but after steam injection and heating during processes 100, 200, 300, 400, and 500, in step 910 an amount of feedstock and water stream may be removed from feedstock cleaning process 100, 200, 300, 400, and 500 and supplied to a multi-separation process, such as process 950 described below in reference to FIG. 9.

Cleaned feedstock 908 may be collected from step 906.

Water 912 may be provided to water cleanup process 800 (step 914) and/or recycled back to step 906 and/or step 902 via water recycling process 500. In step 914, water cleanup process 800 produces clean water 916. Clean water 916 may be collected and/or recycled back to step 906, or step 902.

The present disclosure provides a product stream multi-separation process 950, as shown in FIG. 9. Process 950 separates water from feedstock streams using multiple separators. Process 950 may use any feedstock and water stream, or “pressurized feedstock and water stream 952,” from processes 100, 200, 300, 400, or 500 (FIGS. 1-5) following steam injection. For example, in one embodiment, process 950 may use product stream 114 of process 100 in FIG. 1, product stream 214 of process 200 in FIG. 2, reactor effluent 314 of process 300 in FIG. 3, product stream 414 of process 400 in FIG. 4, and heated and pressurized feedstock and water stream 510 of process 500 in FIG. 5 as pressurized feedstock and water stream 952.

Pressurized feedstock and water stream 952 may have a starting temperature from 200° C., 250° C., or 270° C. to 300° C., 350° C., or 370° C., or any range using any two of the foregoing values as endpoints, such as from 200° C. to 370° C., 250° C. to 350° C., or 270° C. to 300° C.

The initial pressure of pressurized feedstock and water stream 952 may be from 500 psig, 600 psig, or 700 psig to 800 psig, 900 psig, or 1000 psig, or any range using any two of the foregoing values as endpoints, such as from 500 psig to 1000 psig, 600 psig to 900 psig, or 700 psig to 800 psig.

Process 950 may comprise multiple separators, such as decanters. Process 950 may comprise at least two separators, as least three separators, at least four separators, at least five separators, at least six separators, or any range using any two of the foregoing values as end points, such as from two to six separators, from three to five separators, or from three to four separators.

In one embodiment, process 950 uses a first decanter 954, a second decanter 964, and a third decanter 974. Pressurized feedstock and water stream 952 is provided to first decanter 954. First decanter 954 may be high pressure decanter and allow for pressurized feedstock and water stream 952 to separate into a first purified light phase 956 from a heavy phase 960. Pressurized feedstock and water stream 952 may be kept at a pressure within first decanter 954 greater than 500 psig, greater than 600 psig, greater than 700 psig, greater than 800 psig, greater than 900 psig, or greater than 1000 psig, or any range using any two of the foregoing values as endpoints, such as from 500 psig to 1000 psig, 600 psig to 900 psig, or 700 psig to 800 psig.

Pressurized feedstock and water stream 952 may have a residence time within first decanter 954 from 1 second, 30 seconds, or 1 min to 30 min, 60 min, or 120 min, or any range using any two of the foregoing values as endpoints, such as from 1 second to 120 min, 30 seconds to 60 min, or from 1 min to 30 min.

First purified light phase 956 may comprise a cleaned feedstock stream. First purified light phase 956 may be removed from first decanter 954 at a rate from 45 #/hr, 50 #/hr, or 55 #/hr to 60 #/hr, 65 #/hr, or 70 #/hr, or any range using any two of the foregoing values as endpoints, such as from 45 to 70 #/hr, from 50 to 65 #/hr, or from 55 to 60 #/hr.

First purified light phase 956 may be provided to a metering device 958 configured to measure and control the flow of first purified light phase 956 to regulate the flow, pressure, temperature, and/or volume of the first purified light phase 956. The metered flow of first purified light phase 956 may be supplied to a product storage tank (not shown) until use.

Heavy phase 960 may comprise a mixture of feedstock and water. Heavy phase 960 may be removed from first decanter 954 at a rate from 30 #/hr, 35 #/hr, or 40 #/hr to 45 #/hr, 50 #/hr, or 55 #/hr, or any range using any two of the foregoing values as endpoints, such as from 30 to 55 #/hr, from 35 to 50 #/hr, or from 40 to 45 #/hr.

Heavy phase 960 may be provided to second decanter 964 to further separate out feedstock from water. Second decanter 964 may be high pressure and allow for heavy phase 960 to separate into an intermediate phase 966 and a water stream 980. Heavy phase 960 may be kept at a pressure within second decanter 964 greater than 300 psig, greater than 400 psig, greater than 500 psig, greater than 600 psig, greater than 700 psig, or greater than 800 psig, or any range using any two of the foregoing values as endpoints, such as from 300 psig to 800 psig, 400 psig to 700 psig, or 500 psig to 600 psig.

Heavy phase 960 may have a residence time within second decanter 964 from 1 second, 30 seconds, or 1 min to 30 min, 60 min, or 120 min, or any range using any two of the foregoing values as endpoints, such as from 1 second to 120 min, 30 seconds to 60 min, or from 1 min to 30 min.

Intermediate phase 966 may comprise a mixture of feedstock and water. Intermediate phase 966 may be removed from second decanter 964 at a rate from 5 #/hr, 10 #/hr, or 15 #/hr to 20 #/hr, 25 #/hr, or 30 #/hr, or any range using any two of the foregoing values as endpoints, such as from 5 to 30 #/hr, from 10 to 25 #/hr, or from 15 to 20 #/hr.

Intermediate phase 966 may be provided to a cooler 968 to form cooled intermediate phase 970. Cooler 968 may cool intermediate phase to a temperature from 100° C., 120° C., or 140° C. to 160° C., 180° C., or 200° C., or any range using any two of the foregoing values as endpoints, such as from 100° C. to 200° C., 120° C. to 180° C., or 140° C. to 160° C.

Cooled intermediate phase 970 may be provided to third decanter 974. Third decanter 974 may be configured to allow for cooled intermediate phase 970 to separate into a second purified light phase 976 and wastewater 978. Third decanter 974 may be a low pressure decanter. Cooled intermediate phase 970 may be kept at a pressure within third decanter 974 less than 600 psig, less than 500 psig, less than 400 psig, less than 300 psig, less than 200 psig, or less than 100 psig, or any range using any two of the foregoing values as endpoints, such as from 100 psig to 600 psig, 200 psig to 500 psig, or 300 psig to 400 psig.

Cooled intermediate phase 970 may have a residence time within third decanter 974 from 1 second, 30 seconds, or 1 min to 30 min, 60 min, or 120 min, or any range using any two of the foregoing values as endpoints, such as from 1 second to 120 min, 30 seconds to 60 min, or from 1 min to 30 min.

Second purified light phase 976 may comprise a cleaned feedstock stream and be removed from third decanter 974 at a rate from 5 #/hr, 10 #/hr, or 15 #/hr to 20 #/hr, 25 #/hr, or 30 #/hr, or any range using any two of the foregoing values as endpoints, such as from 5 to 30 #/hr, from 10 to 25 #/hr, or from 15 to 20 #/hr. Second purified light phase 976 may be further stored in a product storage tank (not shown) until use.

Wastewater 978 may be removed from third decanter 974 at a rate from 5 #/hr, 10 #/hr, or 15 #/hr to 20 #/hr, 25 #/hr, or 30 #/hr, or any range using any two of the foregoing values as endpoints, such as from 5 to 30 #/hr, from 10 to 25 #/hr, or from 15 to 20 #/hr.

Water stream 980 may comprise water and be removed from second decanter 964 at a rate from 10 #/hr, 15 #/hr, or 20 #/hr to 25 #/hr, 30 #/hr, or 35 #/hr, or any range using any two of the foregoing values as endpoints, such as from 10 to 35 #/hr, from 15 to 30 #/hr, or from 20 to 25 #/hr. Water stream 980 may be provided to a metering device 982 configured to measure and control the flow of water stream 980 to regulate the flow, pressure, temperature, and/or volume of the water stream 980. Water steam 980 may recycled for use in other processes, such as process 100, 200, 300, 400, 500, or 600 in FIGS. 1-6. Alternatively or additionally, water stream 980 may be expelled as wastewater.

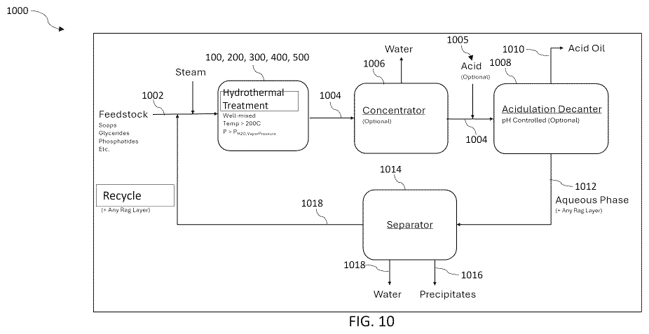

As shown in FIG. 10, the present disclosure provides a soapstock acidulation (or “soap splitting”) process 1002.

Soapstock may comprise a mixture of water, triglycerides, soaps, and phospholipids. It may be desirable to recover the soaps in the form of free-fatty acids (FFAs). The process of soap acidulation comprises adding concentrated acid, such as sulfuric acid, to the soapstock to convert the soapstock into FFAs. The acidulation process produces an organic phase referred to as “acid oil” comprising the FFAs, an aqueous phase referred to as “acid water” comprising neutralized acid-base salts, and a viscous rag layer comprising unreacted components of the soapstock.

The ability of the phospholipids to form emulsions results in the rag layer and entrains portions of the other products, decreasing the yield and inhibiting mixing in the acidulation process. At normal acidulation conditions (temperatures greater than 100° C. and atmospheric pressure), phospholipids may not be affected by the acidulation process and form the rag layer. The non-Newtonian behavior of liquid soapstock makes it difficult to separate the rag layer from the aqueous phase.

Subjecting the soapstock to conditions where the phospholipids are hydrolyzed (temperatures above 200° C. in the presence of liquid water) before acidulation reduces the phospholipid content of the mixture. Processes 100, 200, 300, 400, 500 of the present disclosure may use steam injection to hydrolyze the phospholipids of a soapstock stream 1002 in during the soap acidulation process 1000 of the present disclosure.

Soapstock stream 1002 may be provided to one of processes 100, 200, 300, 400, 500 and undergo steam injection, raising the temperature above 200° C., hydrolyzing the phospholipids, forming hydrolyzed soapstock stream 1004.

Optionally, additives, such as sugar and other additives described above, may be added to soapstock 1002 prior to steam injection during process 100, 200, 300, 400, or 500. The additive may decrease the pH of soapstock 1002.

Process 1000 may not include mixing mechanisms such as recirculation and mechanical mixers. The steam injection of processes 100, 200, 300, 400, and 500 provide mixing of the soapstock stream without outside mixing mechanisms.

The benefits of subjecting soapstock steam 1002 to process 100, 200, 300, 400, or 500 may include: hydrolyzation of phospholipids, such as diglycerides and triglycerides, during process 100, 200, 300, 400, or 500; reduced acid requirements during process 1000 as compared to known soapstock acidulation processes; and a smaller or eliminated rag layer during acidulation, allowing for better mixing during process 1000.

Hydrolysis of glycerides produces FFAs, which are recovered in acid oil 1010 from decanter 1008 (discussed further below), increasing the yield of FFA product. Hydrolysis of the phosphate moiety from the phospholipids may produce a diglyceride and a dihydrogen phosphate or trihydrogen phosphate. These phosphates decrease the pH of the soapstock stream, therefore decreasing the need for the addition of acid prior to separating the acid oil from the aqueous phase. And finally, lower amounts of FFAs are entrained in the rag layer due to the hydrolysis, increasing the yield of acid oil of process 1000 and reducing the size of the rag layer.

Referring back to FIG. 10, hydrolyzed soapstock stream 1004 may optionally be provided to a concentrator 1006, where water is removed from hydrolyzed soapstock stream 1004. Prior to entering an acidulation decanter 1008, hydrolyzed soapstock stream 1004 may comprise less than 40 vol. %, less than 35 vol. %, less than 30 vol. %, less than 25 vol. %, less than 20 vol. %, or less than 15 vol. % of water, or any range using any two of the foregoing values as endpoints, such as from 15 vol. % to 40 vol. %, from 20 vol. % to 35 vol. %, or from 25 vol. % to 30 vol. %, based on the total volume of hydrolyzed soapstock stream 1004.

Additionally, an acid 1005, such as sulfuric or phosphoric acid, may optionally be added to hydrolyzed soapstock stream 1004. However, acid 1005 may not be necessary to split hydrolyzed soapstock stream 1004 into acid oil and an aqueous phase due to the decreased pH caused by the hydrolysis of the phospholipids and potentially any additional additives added during process 100, 200, 300, 400, or 500.

Hydrolyzed soapstock stream 1004 may then be add to decanter 1008 to separate out acid oil 1010 and the aqueous phase (or “acid water”) 1012 using gravity. Decanter 1008 may optionally be pH controlled by the addition of additives, such as acids and bases such that decanter 1008 is kept at a pH between from 2, 3 to 4, 6, or any range using any two of the foregoing values as endpoints, such as from 2 to 6, or from 3 to 4.

Acid oil 1010 may be separated out of decanter 1008 and collected for further use. Acid oil 1010 comprises FFAs may be used in other processes, such as in the production of biodiesel, soaps, detergents, feed, and as fuel for boilers.

Aqueous phase 1012 may be separated out of decanter 1008 and provided to a separator 1014. Aqueous phase 1012 may comprise neutralized acid-base salts and any rag layer with unreacted components of the soapstock, if present. However, due to soapstock 1002 being run through process 100, 200, 300, 400, or 500, many phospholipids should be hydrolyzed, reducing the size of or eliminating the rag layer and the formation of salt precipitates. Aqueous phase may comprise less than 10%, less than 8%, less than 6%, less than 4%, less than 2%, or less than 1%, or any range using any two of the foregoing as values, such as 1-10%, 2-8%, or 4-6%, of a rag layer.

Aqueous phase 1012 may be provided to a separator 1014 to separate out precipitates 1016, if present, and acidic water 1018. Acidic water 1018, which may comprise any rag layer that may be present, may be recycled into soapstock stream 1002 to efficiently recycle water for process 100, 200, 300, 400, or 500 and/or further process any residual rag layer.

### EXAMPLES

The exemplary reactor operating conditions provided in Table 1 can be used for the removal of metals from soybean oil.

### Example 1

In a process conducted according to the scheme in FIG. 2, using the process parameters detailed in Table 1, the contaminants detailed in Table 2 were removed.

TABLE 1
Exemplary Reactor Operating Conditions

| Parameter | Value |
|---|---|
| Oil Flow Rate | 500 to 1000 mL/min |
| Oil Supply Temperature | 20 to 25° C. |
| Oil Supply Pressure | 600 to 800 psig |
| Steam Flow Rate | 20 to 25 lbs/hr |
| Steam Supply Pressure | 700 to 900 psig |
| Mixture Temperature | 200 to 300° C. |
| Mixture Water Content | 10 to 30 mass % |
| Reactor Temperature | 200 to 300° C. |
| Reactor Pressure | 600 to 750 psig |
| Reactor Residence Time | 1 to 3 minutes |
| Reactor Reynolds Number (Re) | 500 to 600 |

The process removes contaminants, such as metal contaminants, from a reactor feedstock, reactor product oil, and centrifuged reactor product oil. Non-limiting examples of contaminants that can be dissociated from feedstock include but are not limited to phosphorous, magnesium, potassium, and calcium. Table 2 shows comparative levels of phosphorus, magnesium, potassium, and calcium removed from crude and water-degummed soybean oil at various stages of a treatment process. Parts per million (ppm) levels of trace metal contaminants was determined using Inductively Coupled Plasma-Atomic Emission Spectrometry (ICP-AES).

TABLE 2
Levels of Inorganic Compounds Removed from Crude Soybean Oil

| Contaminant (ppm) | Reactor Feed | Reactor Product Oil |
|---|---|---|
| Phosphorous | 845.1 | 3.5 |
| Magnesium | 65.0 | <0.1 |
| Potassium | 281 | 0.8 |
| Calcium | 34.3 | 0.2 |

TABLE 3
Levels of Inorganic Compounds Removed
from Water-Degummed Soybean Oil

| Contaminant (ppm) | Reactor Feed | Reactor Product Oil |
|---|---|---|
| Phosphorous | 146.9 | 2.1 |
| Magnesium | 15.7 | 0.3 |
| Potassium | 19.1 | 1.6 |
| Calcium | 33.6 | 1.0 |

### Example 2

In the water recycling process described herein above, a feedstock and water stream may be heated to a temperature above 110° C. to simulate a flash vessel for depressurizing and cooling the mixture.

Contaminants may be removed from the feedstock by flash evaporation and/or water washing, as shown in Table 4.

The ICP results on oil were largely unchanged.

TABLE 4
Flash Evaporation on Feedstock and Water Stream

| | Ca | K | Mg | Na | P | Total |
|---|---|---|---|---|---|---|
| Sample | (Calcium) | (Potassium) | (Magnesium) | (Sodium) | (Phosphorus) | (ppm) |
| 1 | 8.86 | 0.00 | 2.85 | 0.37 | 14.56 | 27.42 |
| 2 (Flash) | 9.53 | 0.56 | 2.14 | 0.36 | 18.57 | 32.71 |
| 3 (Flash and | 6.66 | 0.00 | 1.37 | 0.32 | 13.54 | 23.22 |
| water washed) | | | | | | |

Although the present invention has been described in detail, it should be understood that various changes, substitutions, and alterations can be made without departing from the principle and scope of the invention.

What is claimed is:

1. A process for treating a feedstock comprising:
combining a feedstock stream and a water stream to form a combined feedstock and water stream;
pressurizing the combined feedstock and water stream above 2 MPa;
adding an additive to at least one of the feedstock stream, the water stream, or the combined feedstock and water stream prior to injecting steam;
injecting steam directly into the combined feedstock and water stream, forming a heated feedstock and water stream,
cooling the heated feedstock and water stream; and
producing a cooled product stream.

2. The process of claim 1, further comprising:
depressurizing the cooled product stream; and
separating the cooled product stream by supplying the cooled product stream to a separator, thereby producing a treated feedstock and a separated water stream, optionally further purifying the treated feedstock.

3. The process of claim 1, further comprising preheating the feedstock before the step of injecting steam.

4. The process of claim 1, further comprising pre-treating the feedstock by steam degumming, enzymatic degumming, water degumming, or a combination thereof prior to the steps of pressurizing the feedstock and injecting steam.

5. The process of claim 2, wherein the separating step comprises centrifugal separation.

6. The process of claim 1, wherein the feedstock comprises a petroleum-based feedstock or a renewable feedstock, and a contaminant.

7. The process of claim 6, wherein the renewable feedstock comprises a glyceride-based lipid.

8. The process of claim 1, wherein the pretreated feedstock is pressurized from 3 to 10 MPa; and wherein the steam has a pressure of from 3 to 10 MPa.

9. The process of claim 1, wherein the steam injection step heats the feedstock to a temperature above 200° C.

10. The process of claim 1, wherein the cooling step comprises reducing the temperature of the heated feedstock and water stream to 90° C. or less over a period of 30 seconds to 15 minutes, 30 seconds to 10 minutes, 30 seconds to 5 minutes, or 30 seconds to 1 minute, inclusive.

11. The process of claim 1, further comprising supplying the separated water stream to a water reclaiming process, the water reclaiming process comprising:
heating the separated water stream in a first evaporator to a temperature between 120° C. to 160° C., producing a first heated water stream.

12. The process of claim 11, further comprising:
heating the first heated water stream in a second evaporator to a temperature between 110° C. to 150° C., to produce a second heated water stream; and
heating the second water stream in a third evaporator to a temperature between 100° C. to 140° C., to produce a third heated water stream, wherein a volume of the third heated water stream is less than the volume of the separated water stream.

13. The process of claim 12, wherein each of the first, second, and third evaporators produces steam during heating.

14. The process of claim 1, further comprising:
separating the cooled product stream by supplying the cooled product stream to at least one decanter configured to separate a treated feedstock and a product water stream;
recycling the product water stream back into the pretreated feedstock prior to pressurization, wherein the first water stream is at least partially comprising the recycled product water stream.

15. The process of claim 14, further comprising maintaining the heated feedstock and water stream at a laminar flow for a time.

16. The process of claim 1, wherein the additive is at least one of: an acid; a base; an ionic liquid; an organic solvent; a reducing agent; an oxidizing agent; a sugar; and a catalyst.

17. The process of claim 1, wherein the feedstock stream comprises soapstock.

18. The process of claim 17, further comprising:
decanting the heated feedstock and water stream such that the heated feedstock and water stream separates into acid oil and an aqueous phase;
providing the aqueous phase to a separator to separate water from precipitates within the aqueous phase.

19. A process for treating a feedstock comprising:
combining a feedstock stream and a water stream to form a combined feedstock and water stream;
pressurizing the combined feedstock and water stream above 2 MPa;
adding an additive to at least one of the feedstock stream, the water stream, or the combined feedstock and water stream prior to injecting steam;
injecting steam directly into the combined feedstock and water stream, forming a heated feedstock and water stream; and
providing the heated feedstock and water stream to a multi-separation process configured to separate a purified light phase comprising cleaned feedstock from water.

20. The process of claim 19, wherein the multi-separation process comprises:
providing the heated feedstock and water stream to a first decanter configured to separate feedstock from a heavy phase within the heated feedstock and water stream, the heavy phase comprising a combination of water and feedstock;
providing the heavy phase to a second decanter configured to separate an intermediate phase from water within the heavy phase, the intermediate phase comprising a combination of water and feedstock; and
cooling the intermediate phase with a cooler;
providing the intermediate phase to a third decanter configured to separate feedstock from water within the intermediate phase.

21. The process of claim 20, wherein water from the second decanter may be recycled back into the water stream.

22. The process of claim 20, further comprising:
removing feedstock at a rate from 45-70 #/hr from the first decanter;
removing the heavy phase at a rate from 30-55 #/hr from the first decanter; and
removing the intermediate phase at a rate from 5-30 #/hr form the second decanter; and
removing water at a rate from 10-35 #/hr from the second decanter.

23. A soap acidulation process for processing soapstock, comprising:
combining a soapstock stream and a water stream to form a combined soapstock and water stream;
pressurizing the combined soapstock and water stream above 2 MPa;
injecting steam directly into the pretreated combined feedstock and water stream, forming a heated soapstock and water stream;
decanting the heated soapstock and water stream such that the heated soapstock and water stream separates into acid oil and an aqueous phase;
providing the aqueous phase to a separator to separate water from precipitates within the aqueous phase.

24. The soap acidulation process of claim 23, wherein acid oil comprises free fatty acids.

25. The soap acidulation process of claim 23, further comprising adding an additive to at least one of the soapstock stream, the water stream, or the combined soapstock and water stream prior to injecting steam.

26. The soap acidulation process of claim 25, wherein the additive is at least one of an acid and a sugar.

27. The soap acidulation process of claim 23, wherein the water separated out of the aqueous phase is recycled back into the water stream.

28. The soap acidulation process of claim 23, further comprising providing the heated soapstock and water stream to a concentrator configured to remove water from the heated soapstock and water stream.

29. The soap acidulation process of claim 23, further comprising adding acid to the heated soapstock and water stream.

30. The soap acidulation process of claim 23, wherein the aqueous phase comprises less than 10% of unreacted components of the soapstock stream.
